(19) United States
(12) Patent Application Publication
(10) Pub. No.: US 2007/0109795 A1
(43) Pub. Date: May 17, 2007

(54) Thermal dissipation system

(76) Inventors: Algimantas J. Gabrius, Oxford, GA (US); John Thomas Mayfield III, Loganville, GA (US)

Correspondence Address: NEEDLE & ROSENBERG, P.C., SUITE 1000, 999 PEACHTREE STREET, ATLANTA, GA, 30309-3915, US

(21) Appl. No.: 11/274,673

(22) Filed: Nov. 15, 2005

(51) Int. Cl. F21V 29/00

(52) U.S. Cl. 362/373

(57) ABSTRACT

The present invention is a thermal dissipation system for a ballast of a lighting system. The thermal dissipation system comprises a ballast housing that is adapted for engagement with an elongate support of a common lighting system. The ballast housing comprises a thermally conductive material and is made to substantially house a ballast therein. The ballast housing has a body and thermal transfer surfaces that are shaped to substantially conform to portions of the inner surface of the support. In one aspect, the thermal transfer surfaces of the ballast housing are integral with the body of the housing. In another aspect, the ballast is housed within the body.

### FIELD OF THE INVENTION

The present invention pertains to the field of lighting assemblies, and particularly, to lighting assemblies with systems for dissipation of heat from ballasts.

### BACKGROUND OF THE INVENTION

Fluorescent lamps are becoming increasingly popular in both commercial and residential applications. Fluorescent lamps are more energy efficient and last longer than traditional incandescent lights. In use, the visible light from a fluorescent lamp is produced by a mixture of phosphors inside the lamp. They give off light when exposed to ultraviolet radiation released by mercury atoms as they are bombarded by electrons. The flow of electrons is produced by an arc between two electrodes at the ends of the lamp.

It is well known that the ambient temperature around a fluorescent lamp can have a significant effect on light output and lamp efficiency. At high temperatures, an excess of mercury vapor is present, absorbing the UV radiation before it can reach the phosphors. Therefore, light output drops. Further, high ambient temperatures may be produced around enclosed fluorescent lamps in interior lighting applications. In all lighting applications however, the ballasts will introduce a substantial amount of heat into the fixtures. The IES Lighting Handbook points out that a 1% loss in light output (for fluorescent lamps in general) can be expected for every 2° F. (1.1° C.) above the optimum ambient temperature. Efficiency can also drop, to some degree, at these higher temperatures. It is, therefore, desirable to try to dissipate as much heat from the system as possible.

### SUMMARY

The present invention is a thermal dissipation system for a ballast of a lighting system. The thermal dissipation system comprises a ballast housing that is adapted for engagement with an elongate support of a lighting system. The ballast housing comprises a thermally conductive material and is adapted to substantially house a ballast therein. The ballast housing has a body and thermal transfer surfaces that are shaped to substantially conform to portions of the inner surface of the support. In one aspect, the thermal transfer surfaces of the ballast housing are integral with the body of the housing. In another aspect, the ballast is housed within a portion of the body.

The purpose of forming the thermal transfer surfaces to conform to portions of the inner surface of the support is to provide a large surface area for conducting heat from the ballast to the support, for eventual dissipation to the ambient surroundings. In one aspect of the invention, the more surface area of the ballast housing that is in contact with the inner surface of the support, the better and/or more efficient the thermal dissipation provided by the system of the present invention.

### DETAILED DESCRIPTION OF THE DRAWINGS

These and other features of the preferred embodiments of the present invention will become more apparent in the detailed description, in which reference is made to the appended drawings wherein:

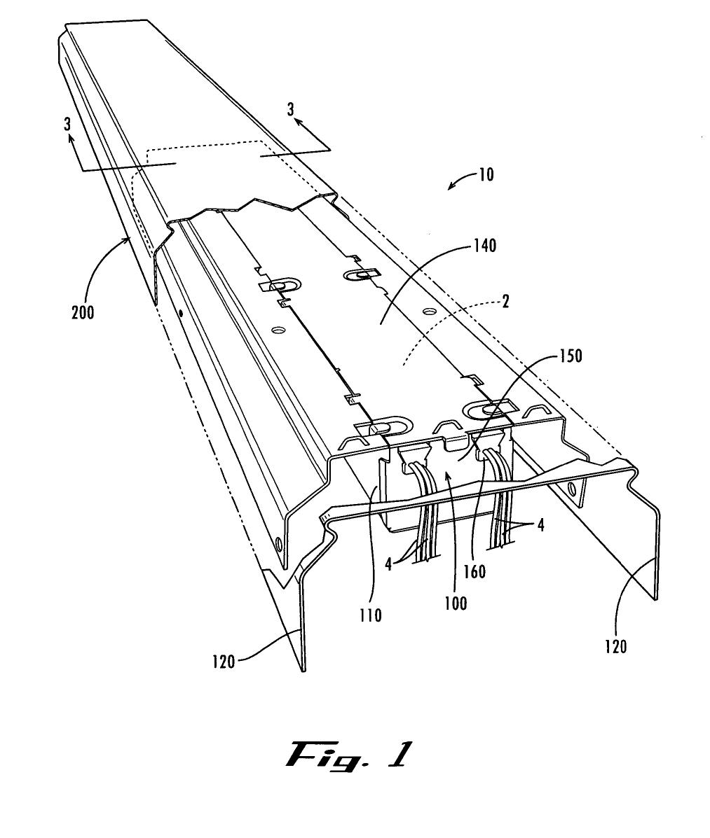

FIG. 1 is a partial cut away perspective view of one aspect of the present invention for a thermal dissipation system for a ballast of a lighting system.

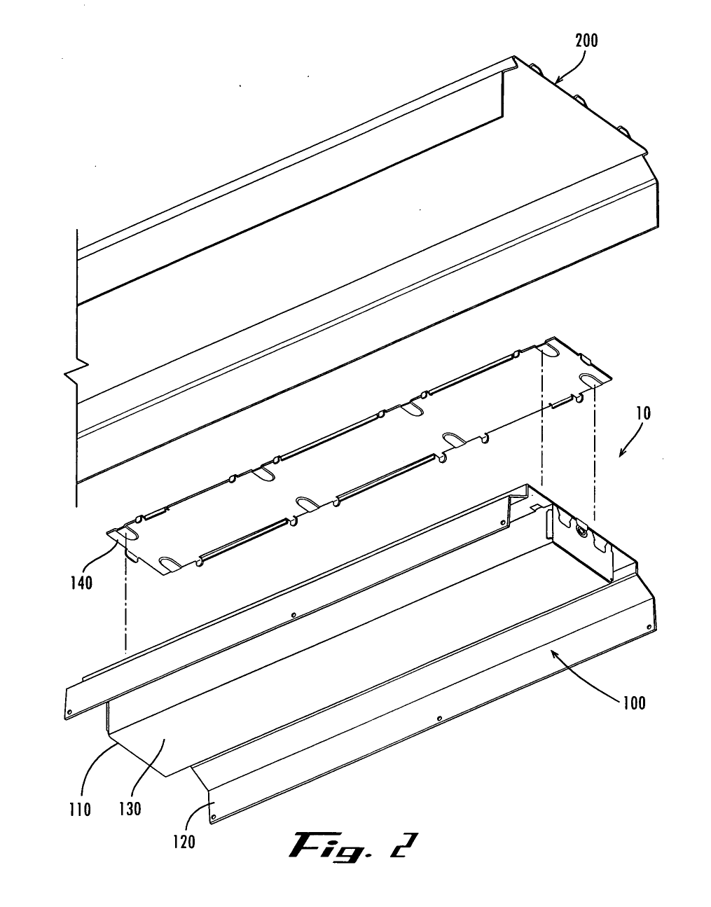

FIG. 2 is an exploded perspective view of the thermal dissipation system of FIG. 1, showing the elongate support, the ballast housing, and the elongate trough cover plate.

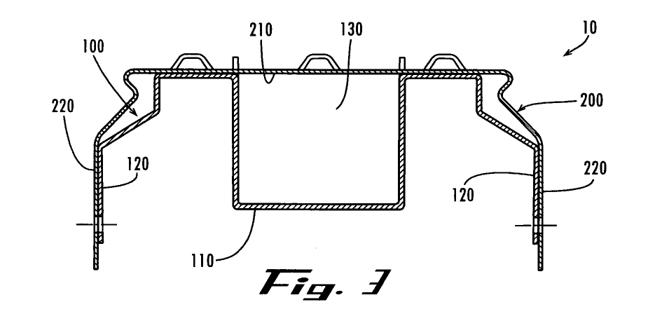

FIG. 3 is a cross-sectional view of the thermal dissipation system of FIG. 1 taken along line 3-3 of FIG. 1, showing the ballast housing engaged with the elongate support.

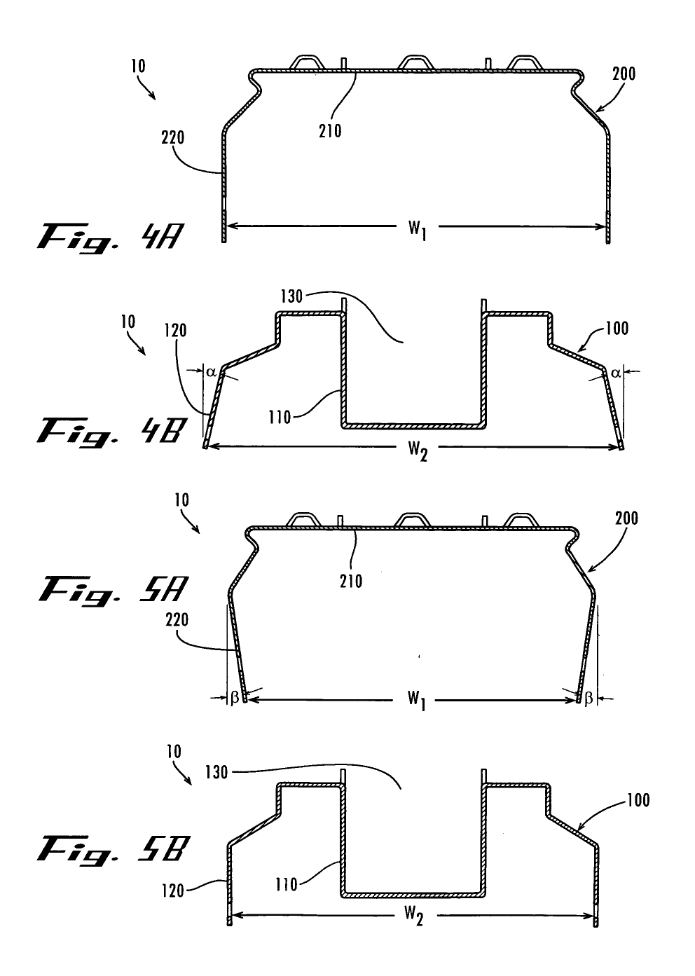

FIG. 4A is a cross-sectional view of one embodiment of the elongate support for the thermal dissipation system of the present invention, showing a pair of opposing surfaces in an unengaged position.

FIG. 4B is a cross-sectional view of one embodiment of the ballast housing for the thermal dissipation system of the present invention, showing the thermal transfer surfaces of the ballast housing in an unengaged position, the thermal transfer surfaces adapted for a friction fit with portions of the pair of opposing surfaces of the elongate support of FIG. 4A.

FIG. 5A is a cross-sectional view of one embodiment of the elongate support for the thermal dissipation system of the present invention, showing a pair of opposing surfaces in an unengaged position and showing the pair of opposing surface being angled away from each other.

FIG. 5B is a cross-sectional view of one embodiment of the ballast housing for the thermal dissipation system of the present invention, showing the thermal transfer surfaces of the ballast housing in an unengaged position, the thermal transfer surfaces adapted for a friction fit with portions of the pair of opposing surfaces of the elongate support of FIG. 5A.

### DETAILED DESCRIPTION OF THE INVENTION

The present invention is more particularly described in the following exemplary embodiments that are intended as illustrative only since numerous modifications and variations therein will be apparent to those skilled in the art. As used herein, “a,” “an,” or “the” can mean one or more, depending upon the context in which it is used. The preferred embodiments are now described with reference to the figures, in which like reference characters indicate like parts throughout the several views.

Ranges may be expressed herein as from “about” one particular value, and/or to “about” another particular value. When such a range is expressed, an alternate embodiment includes from the one particular value and/or to the other particular value. Similarly, when values are expressed as approximations, by use of the antecedent “about,” it will be understood that the particular value forms another embodiment.

In one aspect, the present invention provides a thermal dissipation system 10 for a ballast 2 of a lighting system. The thermal dissipation system 10 comprises a ballast housing 100 that is adapted for engagement with an elongate support 200 of a common lighting system. In one aspect, the support 200 may be, in some instances, what is typically referred to in the lighting industry as a ballast channel and the ballast housing may be positioned within the channel. However, it will be appreciated that a number of supports of varying shapes and sizes are contemplated.

The ballast housing 100 comprises a thermally conductive material and is made to substantially house the ballast 2 therein. The thermally conductive material may be, for example and without limitation, aluminum, steel, copper, and the like. The ballast housing 100 has a body 110 and thermal transfer surfaces 120 that are shaped to substantially conform to portions of the inner surface 210 of the support. In one aspect, as illustrated in FIG. 3, the thermal transfer surfaces 120 of the ballast housing are integral with the body 110 of the housing. In a further aspect, the ballast is housed within the body 110, as illustrated in FIG. 3.

In one aspect, the purpose of conforming at least portions of the thermal transfer surfaces 120 to complementary portions of the inner surface 210 of the support 200 is to increase or maximize the amount of conjoined, thermally conductive surface area between the elongate support and the thermally conductive ballast housing. This, in turn, increases or maximizes the ability of the system 10 of the present invention to conduct heat from the ballast to the support, for eventual dissipation to the ambient surroundings. Thus, the more surface area of the ballast housing that is in contact with the inner surface of the support, the better or more efficient the thermal dissipation of the system.

In one example, at least 40% of the thermal transfer surfaces 120 of the ballast housing 100 substantially contact portions of the inner surface of the support 200. In another example, at least 80% of the thermal transfer surfaces of the ballast housing substantially contact portions of the inner surface of the support 200.

As mentioned above, it is desirable to have as much surface area in contact between the support and the thermal transfer surfaces of the ballast housing 100. As can be appreciated, when the ballast housing is mounted thereon the support, portions of the support may have a tendency to bend and move away from the housing. To counter this effect, in one aspect of the invention, the support comprises a pair of opposing surfaces 220. Where the support is a ballast channel, the opposing surfaces 220 may be the sides of the channel. In this aspect, at least one of the sides of the channel is movable from a first unengaged position in which the support 200 is not engaged with the ballast housing 100 to a second engaged position. In one aspect and referring to FIGS. 5A and 5B, in this first unengaged position, the pair of opposing surfaces are biased inwardly toward each other at a predetermined angle β. In this position, the opposing surfaces are spaced a distance of W₁. In the second engaged position, in which the support 200 is engaged with the ballast housing 100, the pair of opposing surfaces 220 are biased outwardly from the first position, resulting in a spaced relationship between the opposing surfaces substantially equal to the spaced relationship of the thermal transfer surfaces, W₂. Thus, when the ballast housing is mounted thereon the support, there will be a thermal friction fit between portions of the pair of opposing surfaces and portions of the thermal transfer surfaces 120. As a result, there is more surface area in contact between the thermal transfer surfaces of the housing and the support.

Similarly, in an alternative aspect and referring now to FIGS. 4A and 4B, the above mentioned result may also be obtained by biasing the thermal transfer surfaces 120 of the housing in lieu of the opposing surfaces 220 of the support. In this aspect, the thermal transfer surfaces 120 may be moveable from a first unengaged position in which the ballast housing is not engaged with the support to a second engaged position. In this aspect, in the first unengaged position, portions of the thermal transfer surfaces are biased outwardly away from the body of the ballast housing at a predetermined angle α, resulting in a spaced relationship of W₂. In the second engaged position, in which the ballast housing 100 is engaged with the support, portions of the thermal transfer surfaces are biased inwardly from the first position, resulting in a spaced relationship substantially equal to the spaced relationship of support surfaces W₁. Thus, a thermal friction fit is formed between portions of the thermal transfer surfaces and portions of the pair of opposing surfaces.

In another aspect of the invention, the housing defines a trough 130 sized and shaped to accept the ballast 2 therein. The trough 130 and the thermal transfer surfaces 120 may be, for example, formed from a single sheet of material. However, as one skilled in the art can appreciate, the trough may be formed in many various ways. In one aspect, as illustrated in FIG. 2, the trough overlies the inner surface 210 of the support 200. In yet another aspect, the inner surface of the support and the trough 130 substantially envelops the ballast positioned therein.

In another aspect and as illustrated in FIG. 2, the trough may be covered by an elongate trough cover plate 140 substantially underlying the trough 130 and substantially overlying the inner surface of the support. As can be appreciated, the trough cover plate 140 may be in thermal communication with at least one of the thermal transfer surfaces 120. The trough cover plate may also be in thermal communication with a portion of the inner surface 210 of the support 200. This facilitates increased thermal transfer between the ballast, the ballast housing, and the support 200.

Since the ballast is housed within the trough 130 of the ballast housing 100, it may be desirable to further have an endcap 150 thereon one or both ends of the trough of the ballast housing, substantially enclosing the respective end of the trough. In order to facilitate electrical wiring 4, in one aspect, the endcap 150 defines at least one bore 160 therethrough, sized to enable at least one electrical conductor to pass from an interior portion of the trough of the ballast housing through the bore 160.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

We claim:

1. A thermal dissipation system for a ballast of a lighting system, comprising:
an elongate support for mounting to the lighting assembly, the support having an inner surface that has a defined cross-sectional shape;
a thermally conductive ballast housing adapted for engagement with the support and for mounting the ballast therein, the housing having a body and thermal transfer surfaces that are shaped to substantially conform to portions of the inner surface of the support.

2. The thermal dissipation system of claim 1, wherein the thermal transfer surfaces of the ballast housing are integral with the body of the housing.

3. The thermal dissipation system of claim 1, wherein at least 40% of the thermal transfer surfaces of the ballast housing substantially contact portions of the inner surface of the support.

4. The thermal dissipation system of claim 1, wherein at least 80% of the thermal transfer surfaces of the ballast housing substantially contact portions of the inner surface of the support.

5. The thermal dissipation system of claim 1, wherein the ballast housing comprises aluminum.

6. The thermal dissipation system of claim 1, wherein the elongate support is a ballast channel.

7. The thermal dissipation system of claim 6, wherein the ballast housing is positioned within the channel.

8. The thermal dissipation system of claim 1, wherein a ballast is mounted therein the body of the ballast housing.

9. The thermal dissipation system of claim 1, wherein the support comprises a pair of opposing surfaces, wherein, in a first unengaged position in which the support is not engaged with the ballast housing, the pair of opposed surfaces are biased inwardly toward each other at a predetermined angle, and wherein in a second engaged position, in which the support is engaged with the ballast housing, the pair of opposed surfaces are biased outwardly from the first position for a thermal friction fit between portions of the pair of opposing surfaces and portions of the thermal transfer surfaces.

10. The thermal dissipation system of claim 1, wherein the support comprises a pair of opposing surfaces, wherein, in a first unengaged position in which the ballast housing is not engaged with the support, portions of the thermal transfer surfaces are biased outwardly away from the body of the ballast housing at a predetermined angle, and wherein in a second engaged position, in which the ballast housing is engaged with the support, the portions of the thermal transfer surfaces are biased inwardly from the first position for a thermal friction fit between portions of the thermal transfer surfaces and portions of the pair of opposing surfaces.

11. A thermal dissipation system for a ballast of a lighting system, comprising:
an elongate support having an inner surface that has a defined cross-sectional shape;
a thermally conductive ballast housing adapted for engagement with the support and for mounting the ballast therein, the housing having thermal transfer surfaces that are shaped to substantially conform to portions of the inner surface of the support, wherein the housing defines a trough sized and shaped to accept the ballast therein.

12. The thermal dissipation system of claim 11, wherein the trough overlies the inner surface of the support.

13. The thermal dissipation system of claim 12, wherein the inner surface of the support and the trough substantially envelops the ballast positioned therein.

14. The thermal dissipation system of claim 12, further comprising an elongate trough cover plate substantially underlying the trough and substantially overlying the inner surface of the support.

15. The thermal dissipation system of claim 14, wherein at least a portion of the trough cover plate is in thermal communication with at least one of the thermal transfer surfaces.

16. The thermal dissipation system of claim 14 or 15, wherein at least a portion of the trough cover plate is in thermal communication with a portion of the inner surface of the support.

17. The thermal dissipation system of claim 11, further comprising an endcap thereon an end of the trough of the ballast housing, substantially enclosing the respective end of the trough.

18. The thermal dissipation system of claim 17, wherein the endcap defines at least one bore therethrough, sized to enable at least one electrical conductor to pass from an interior portion of the trough of the ballast housing through the bore.

19. The thermal dissipation system of claim 11, wherein the support comprises a pair of opposing surfaces, wherein, in a first unengaged position in which the support is not engaged with the ballast housing, the pair of opposed surfaces are biased inwardly toward each other at a predetermined angle, and wherein in a second engaged position, in which the support is engaged with the ballast housing, the pair of opposed surfaces are biased outwardly from the first position for a thermal friction fit between portions of the pair of opposing surfaces and portions of the thermal transfer surfaces.

20. The thermal dissipation system of claim 11, wherein the support comprises a pair of opposing surfaces, wherein, in a first unengaged position in which the ballast housing is not engaged with the support, portions of the thermal transfer surfaces are biased outwardly away from the body of the ballast housing at a predetermined angle, and wherein in a second engaged position, in which the ballast housing is engaged with the support, the portions of the thermal transfer surfaces are biased inwardly from the first position for a thermal friction fit between portions of the thermal transfer surfaces and portions of the pair of opposing surfaces.
